(19) United States
(12) Patent Application Publication
(10) Pub. No.: US 2021/0276899 A1
(43) Pub. Date: Sep. 9, 2021

(54) WATER TREATMENT SYSTEM

(71) Applicant: Claudia Staindel, Vienna (AT)

(72) Inventor: Peter Koch, Vienna (AT)

(21) Appl. No.: 16/624,028

(22) PCT Filed: Jun. 19, 2018
(86) PCT No.: PCT/AT2018/000058

§ 371 Date: Dec. 18, 2019

(30) Foreign Application Priority Data
Jun. 22, 2017 (AT) GM 137/2017

(51) Int. Cl. C02F 1/78; C02F 1/00; C02F 1/44; E04H 5/12

(52) U.S. Cl. CPC C02F 1/78; C02F 1/001; C02F 1/442; C02F 2103/023; C02F 2201/784; C02F 2301/026; C02F 2301/043; E04H 5/12

(57) ABSTRACT

In a water treatment system, in particular for cooling towers, comprising a fluid basin and a circulation circuit designed to draw a fluid from the fluid basin and subsequently return it again, the circulation circuit comprising an ozone supply device for introducing ozone into the fluid, it is provided that the ozone supply device comprises a swirl chamber reactor and an ozone generator, which is connected to a filter system having an inlet opening for ambient air such that ambient air cleaned by the filter system, in particular substantially pure oxygen, can be fed to the ozone generator for ozone generation.

The invention relates to a water treatment system, in particular for open water cycles such as cooling towers, air washers, decorative fountains or swimming pools, comprising a fluid basin and a circulation circuit, which is designed to draw a fluid from the fluid basin and subsequently return it again, the circulation circuit comprising an ozone supply device for introducing ozone into the fluid.

The invention further relates to a cooling tower comprising a water treatment system of the initially defined kind, and a method for water treatment.

Cooling towers are, for instance, used in power plants or factories to remove excess heat from the respective processes. To this end, the water to be cooled is sprayed within the interior of the cooling tower, the heat is given off to the air by the water, and water vapour is formed. The cooled water subsequently flows to the bottom of the cooling tower and is collected in a fluid basin, in particular a cooling tower tray. After this, the water is again conducted through a heat exchanger, heated therein, and again sprayed within the cooling tower and cooled. Since part of the water evaporates in the cooling tower and is thus removed from the circuit, fresh water has to he regularly supplied.

Cooling towers are recoolers for the refrigeration process of every refrigeration plant. The present invention is, in particular, concerned with open wet cooling towers. The advantages over closed recoolers are, above all, their reduced space requirement and their superior energy efficiency.

Several problems are faced in an open water circuit. By washing the ambient air, additional contaminants are introduced into the sump to the refilled water. Legionella and bacteria propagate especially rapidly in the water due to the process-related higher water temperatures of 25-40°. In order to eliminate them, biocides must be added. The latter, however, also have a negative effect on the pH value, thus causing increased corrosion. As a result, further chemical substances have to be added to raise the pH and hence re-establish a chemical equilibrium.

Hygienic requirements for cooling towers are regulated by the Directive VDI 2047-2. Said Directive, in particular, defines limit values for Legionella. The limit value for Legionella spp, for instance, is 100 CFU (colony-forming units)/100 ml. Cooling towers, moreover, are subject to the German Federal Immission Control Ordinance (BimSchV—Bundesimmissionsschutzverordnung) such that defined limit values are to be observed, which must also be documented.

Another problem involved, in particular in open systems, in which the water comes into direct contact with ambient air, is the formation of scale. In order to prevent scale buildup on pipes or tubes and heat exchanger surfaces, scale stabilizers are usually added.

The use of chemicals, in particular, involves the drawback that they may be introduced into waste waters or the environment, for instance at a water exchange. On the one hand, this results in elevated costs for the water exchange in order to remove the water and, on the other hand, this involves the risk of environmental pollution.

In order to overcome these drawbacks and, in particular, avoid the use of numerous chemicals, water treatment systems in which ozone is supplied to the water have become known from the prior art. To this end, the ozone is usually admixed in a Venturi nozzle. Ozone offers the advantage of effectively combating Legionella.

The supply of ozone into the water circuit, however, involves the problem that ozone is hardly soluble in water such that the ozone will rapidly outgas from the water before being able to take full effect. In order to avoid outgassing, the fluid, after such an ozone supply, is irradiated by UV-C light using an UV-C tube so as to cause splitting of the ozone and enable reduced outgassing of the ozone.

Therefore, there is the need to further develop a water treatment system of the initially mentioned kind to the effect that the supply of ozone is feasible such that no subsequent conditioning of the water, in particular UV-C irradiation, is necessary to reach a desired ozone level in the water.

To solve this object, is provided that the ozone supply device comprises a swirl chamber reactor and an ozone generator, which is connected to a filter system having an inlet opening for ambient air such that ambient air cleaned by the filter system, in particular substantially pure oxygen, can be fed to the ozone generator for ozone generation. The filter system preferably comprises at least one CO₂ filter and/or at least one N₂ filter. Preferably, a molecular sieve is used as CO₂ filter. Thus, oxygen freed from other components can be fed to the ozone generator so as to enable the ozone generator to produce substantially pure ozone, which is subsequently introduced into the fluid. Ozone substantially free of CO₂ portions, particular pure ozone, has the effect that the pH of the fluid mixed therewith is shifted to the alkaline range, e.g. to a pH of about 8.5-9.5. The introduction of ozone, therefore, not only has the known advantage of killing Legionella and bacteria, but that, due to the elevated pH value, corrosion will be prevented and scale will precipitate in colloidal form with a particle size of about 1-10 μm rather than deposit on lines or on heat exchangers.

The scale particles can be removed by suitable filters, e.g. membranes, with an exclusion limit of at least 0.2-1 μm.

By the introduction by means of a swirl chamber reactor, the effect is achieved that the ozone mixes better and faster with the water due to the, in particular rotary, motion in the swirl chamber reactor. This is presumably based on occurring shearing forces, which cause large portions of the introduced ozone to be more rapidly converted to OH radicals so as to prevent outgassing. Moreover, an additional cleaning effect will be achieved by the cavitation possibly forming in the swirl chamber reactor.

The microbubble formation occurring in the swirl chamber reactor and the thus achieved, deliberate mixing of the ozone with the fluid leads to a. reduction of the surface tension and the viscosity of the fluid. The high pH-value (e.g. >9) provides additional washing quality, thus deposits on pipe surfaces will be prevented and the biofilm can be washed off more easily.

By the water treatment system according to the invention, it is, in particular, possible to observe the limit values specified both in the Directive VDI 2047-2 and in the BimSchV.

By “substantially pure oxygen”, a mixture of at least 90 vol % oxygen, preferably at least 93 vol % oxygen, is understood in the context of the invention. in particular the CO₂ portion is considerably reduced, preferably to a maximum of 0.1% vol, particularly preferably to less then 0.05 vol %.

By “substantially pure ozone”, a mixture of at least 90% ozone, preferably at least 93% ozone, is understood in the context of the invention.

A swirl chamber reactor is meant. to denote a reactor comprising at least one inlet opening and at least one outlet opening for the liquid, said reactor being designed such that the entering liquid passes through a liquid column on its way to the outlet opening, in which liquid column the liquid rotates about the axis formed by the direction of movement of the liquid. The liquid thus advances helically or spirally in said liquid column.

As opposed to a Venturi nozzle, which is usually used for the introduction of ozone, a swirl chamber reactor additionally provides a rotary motion.

The swirl chamber reactor can, for instance, be formed by a chamber in which the liquid is injected in the upper region and conducted along a chamber wall in such a manner as to form a travelling vortex directed with its tip downwards. At the lower vertex, at which a negative pressure ranging from 0.7-0.95 bar is generated, said vortex is preferably mixed with the ozone and subsequently conducted upwards with helical or spiral motion on the inner side of an outlet pipe leading in the opposite direction. The helical or spiral motion ensures good mixing of the ozone with the water.

It is preferably provided that the swirl chamber reactor comprises a Laval nozzle. The latter is preferably disposed in an outlet pipe of the swirl chamber reactor, in particular near the entry opening of the outlet pipe, and further promotes the mixing of the water with the ozone. In this respect, it is particularly preferred that the ozone introduction is provided in. the region of the constriction of the Laval nozzle. In this region a negative pressure is formed, which improves mixing. The flow rate through the nozzle is preferably larger than 10 m/s.

In a particularly preferred configuration, it is provided that the swirl chamber reactor comprises at least two fluid intakes and is preferably spiral-shaped or egg-shaped. The fluid intakes are, in particular, arranged such that the inflowing fluid is each tangentially guided along the reactor wall so as to achieve a helical or spiral motion of the fluid on. the reactor wall. Friction forces are thus caused in the reactor, which break up compounds within the fluid and hence ensure better mixing with the ozone.

Furthermore, it is preferably provided that the circulation circuit comprises a scale filter, in particular a membrane filter, which is preferably comprised of a microfiltration unit with an exclusion limit of preferably 0.2-1 μm, in particular 0.2 μm. Moreover, a scale filter, in particular a membrane filter, with an exclusion limit of about 1 m μm may be provided. Such a filter allows for the effective removal. from the fluid of scale particles and other undesired substances contained in the fluid.

In this context, it is preferably provided that the scale filter is disposed downstream of the ozone supply device, viewed in the flow direction.

Furthermore, it is preferably provided that the fluid basin is connected to a refeeding line. Said refeeding line serves to refill the fluid removed from the cooling circuit, in particular by evaporation or desludging.

In a particularly preferred manner, it is provided that the circulation circuit is connected to a refeeding line opening into the circulation circuit preferably upstream of the ozone supply device, viewed in the flow direction. Upstream of the entry of the refeeding line into the circulation circuit is preferably provided a microbiological entry protection means, which preferably comprises a membrane having an exclusion limit of at least 0.2 μm, preferably 0.1-0.2 μm, and preferably made of an ozone-proof material. Alternatively, a reaction tank with ozone may be provided. In both cases, it is preferably contemplated that the existing swirling flow reactor is used for cleaning the membrane or for enriching the reaction tank by an appropriate residence time of the refeeding fluid. It is thus possible in a simple manner to treat the refilled water with ozone already before feeding it into the fluid basin and the cooling circuit, and hence effectively eliminate bacteria, Legionella and other undesired contaminants of the fluid already beforehand. Since the contamination with Legionella is prevented, they cannot reach the cooling circuit either.

In a particularly efficient configuration, it is provided that the circulation circuit comprises a bypass line designed to draw fluid from the circulation circuit and supply it to the circulation circuit, or to the refeeding line, upstream of the ozone introduction. On the one hand, a sufficient flow rate through the circulation circuit will thus be ensured and, at the same time, a portion of the through flowing fluid will be efficiently treated with ozone. In this case, the ozone supply device may be smaller-structured than in the event that all of the fluid must flow through the swirl chamber reactor during every perfusion. Moreover, the use of valves allows for the control of the flow rate through the circulation circuit and, in particular, through the bypass line according to requirements. The flow rate through the circulation circuit can, for instance, be interrupted during refeeding, which may, for instance, be controlled by a float valve.

This entry protection means makes it possible that no or substantially fewer Legionellae are contained in the fluid than specified by the limit values.

Furthermore, it is preferably provided that a cooling water circuit is provided to draw fluid from the fluid basin and subsequently return it again, wherein the cooling water circuit comprises a heat exchanger. In this case, two fluid circuits are thus provided, i.e. a cooling water circuit for carrying off the heat and a circulation circuit for treating the fluid. As opposed to a joint circuit, which serves both cooling and treat ing, the configuration with separate circuits has, in particular, the advantage that the treatment can be performed more selectively and independently of the cooling process.

In the water treatment system, a central controller is, in particular, provided to monitor various sensors and merge the obtained values, on the one hand, and accordingly control valves, in particular magnetic valves, and other components, on the other hand. The ozone introduction can, in particular, be adapted to the respectively obtained fluid values in order to provide a constant fluid quality.

Furthermore, a cooling tower comprising a water treatment system according to the invention is provided by the invention. The water treatment system is, in particular, suitable for wet cooling towers, in which the fluid is in direct contact with the atmosphere, which is why more contaminants are able to reach the fluid than in dry cooling towers, in which the fluid is screened from direct contact with the atmosphere.

Furthermore, a method for water treatment, particular in a cooling tower, is provided according to the invention, wherein a fluid is conducted from a fluid basin into a circulation circuit, substantially pure ozone is introduced into the fluid in the circulation circuit by means of a swirl chamber reactor, and subsequently the fluid is again returned from the circulation circuit into the fluid basin.

It is preferably provided that the substantially pure ozone is obtained from ambient air, preferably by means of a filter system and an ozone generator. This enables a simple and reliable production of ozone, because the oxygen necessary for the production of ozone can be directly obtained from the ambient air, no separate supply means being necessary therefor.

Furthermore, is preferably provided that the substantia pure ozone is supplied to the fluid in a bypass line.

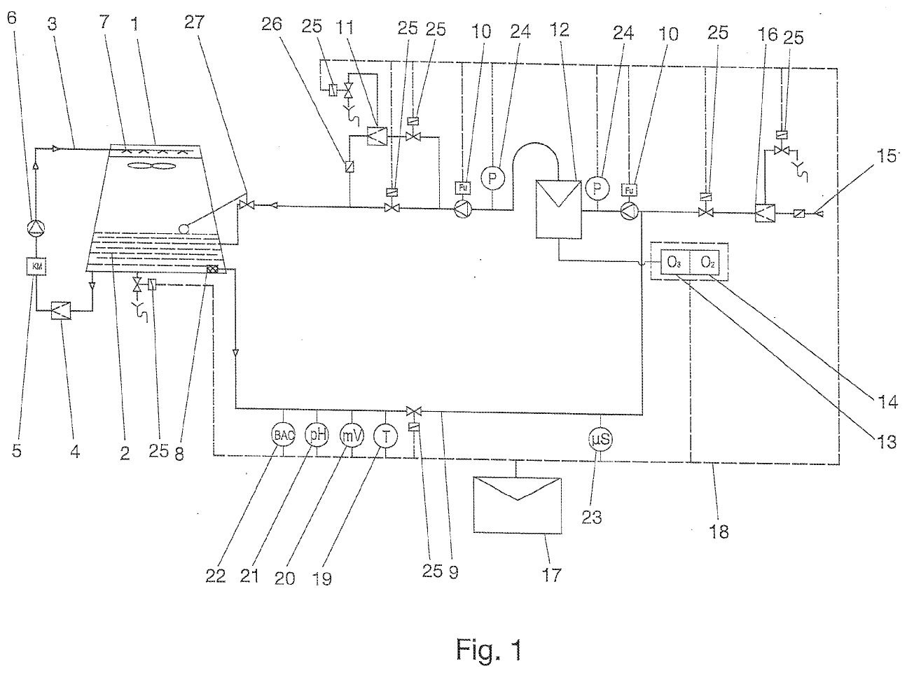

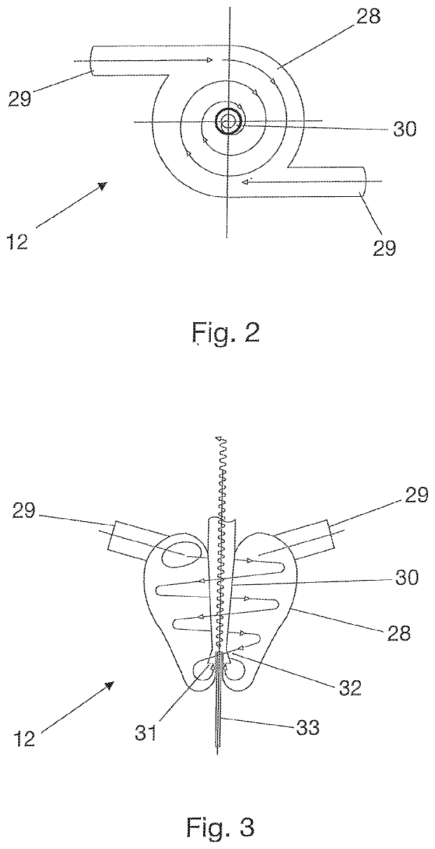

In the following, the invention will be explained in more detail by way of exemplary embodiments schematically illustrated in the drawing. Therein, FIG. 1 depicts a circulation circuit according to the invention; FIG. 2 depicts a first configuration of a swirl chamber reactor; and FIG. 3 depicts a second configuration of a swirl chamber reactor.

In FIG. 1, a cooling tower is denoted by 1, which comprises a fluid basin 2 on its bottom. A cooling circuit 3 comprises an inlet in the region of the fluid basin 2, through which fluid reaches the cooling circuit 3 and is conducted through a filter 4. After this, the drawn fluid is conducted through a heat exchanger in the refrigerating machine 5, and there is heated by the undesired heat. Further disposed in the cooling circuit 3 is a pump 6 for conveying the fluid within the cooling circuit. The fluid heated by the heat exchanger of the refrigerating machine 5 is sprayed through spraying nozzles 7 in the upper region of the cooling tower 1, thus being cooled and/or partially evaporated. The cooled fluid is returned into the fluid basin 2 and from there can be resupplied to the cooling circuit 3.

In the fluid basin 2 there is also provided a suction basket 8, through which fluid is conveyed into the circulation circuit 9 for treating the fluid. Two pumps 10 are disposed in the circulation circuit 9 for transporting the fluid. Moreover, a scale filter 11, which is, for instance, designed as a 20 μm filter, is disposed in the circulation circuit 9 to remove scale particles and similar impurities from the fluid. Upstream of the scale filter 11, an ozone supply device comprising a swirl chamber reactor 12, an ozone generator 13 connected to the swirl chamber reactor 12, and a filter system 14 connected to the ozone generator 13 are provided. The filter system 14 comprises a suction opening, through which ambient air can be sucked in. In the filter system 14 are disposed a CO₂ filter and/or an N₂ filter to obtain substantially pure oxygen from the ambient air. The substantially pure oxygen is subsequently supplied to the ozone generator 13, in which substantially pure ozone is produced, which is subsequently supplied to the fluid in the swirl chamber reactor 12. Downstream of the swirl chamber reactor 12, the drawn fluid is supplied back to the fluid basin 2 via the circulation circuit 9.

Upstream of the swirl chamber reactor 12, moreover, opens the refeeding line 15, which is connected to a fluid reservoir, e.g. a water point, which is not illustrated. The fluid to be refilled is conducted via a microfilter 16 to remove impurities already before the fluid enters the circulation circuit 9.

For controlling the system, a controller 17 is provided, which is connected to the individual elements via schematically illustrated lines 18. The condition of the cooling fluid is continuously monitored by a temperature sensor 19, a redox sensor 20, a pH sensor 21, a BAC sensor 22 and/or a conductance sensor 23. The redox sensor 20 serves to measure the oxidation potential of the cooling fluid, which is an indicator for the quality of the cool fluid. The BAC sensor measures the bacterial load, an the conductance sensor 23 measures the scale load. The pressure sensors 24 serve to control the cavitation in the swirl chamber reactor 12 by means of the pumps 10. The flow rate controlled, and adapted to the respectively required conditions, by the magnetic valves 25. Moreover, a check valve 26 and a float switch 27 are provided to control the return flow of the fluid into the cooling tower 1.

FIG. 2 illustrates a swirl chamber reactor 12 according to the invention. The swirl chamber reactor 12 is spirally designed and comprises a swirl chamber 28, two fluid intakes 29 and an outlet pipe 30. The fluid enters the swirl chamber through the two fluid intakes 29 and is conducted along the edge of the swirl chamber 28 in such a manner as to create a swirl running into an entry opening 31 of the outlet pipe 30 (cf. FIG. 3).

FIG. 3 is a sectional view of the swirl chamber reactor 12 according to FIG. 2. In the region of the entry opening 31 of the outlet 30, a constriction, in particular a Laval nozzle 32, is provided. Moreover, an ozone introduction means 33 is provided in the region of the entry opening 31 of the outlet pipe 30. The fluid enters the swirl chamber 28 through the fluid intakes 29 and is conducted with a schematically indicated spiral motion downwards in the direction to the entry opening 31 of the outlet pipe 30. There, the fluid enters the outlet pipe 30, and the ozone is supplied to the fluid in the region of the Laval nozzle 32 through the ozone introduction means 30. In the region of the Laval nozzle 32 is formed a negative-pressure zone, which has a beneficial effect on the mixing of the ozone with the fluid. After this, the fluid is helically conveyed in the outlet pipe 30 and leaves the swirl chamber reactor 12 again.

1. A water treatment system comprising a fluid basin and a circulation circuit designed to draw a fluid from the fluid basin and subsequently return it again, the circulation circuit comprising an ozone supply device for introducing ozone into the fluid, wherein the ozone supply device comprises a swirl chamber reactor and an ozone generator, that is arranged to introduce ozone into the swirl chamber reactor, wherein the ozone generator is connected to a filter system having an inlet opening for ambient air, wherein the filter system is configured to filter the ambient air to obtain substantially pure oxygen, which is fed to the ozone generator for ozone generation.

2. The water treatment system according to claim 1, wherein the swirl chamber reactor comprises a Laval nozzle.

3. The water treatment system according to claim 1, wherein the swirl chamber reactor comprises at least two fluid intakes.

4. The water treatment system according to claim 1, wherein the circulation circuit comprises a lime filter which is comprised of a microfiltration unit with an exclusion limit of 0.2-1 μm.

5. The water treatment system according to claim 4, wherein the lime filter is disposed downstream of the ozone supply device, viewed in the flow direction.

6. The water treatment system according to claim 1, wherein the circulation circuit is connected to a refeeding line opening into the circulation circuit upstream of the ozone supply device, viewed in the flow direction.

7. The water treatment system according to claim 6, characterized in that the refeeding line comprises a microfiltration with an exclusion limit of preferably <0.2 μm and/or an ozone supply device comprising a swirl chamber reactor.

8. The water treatment system according to claim 1, characterized in that the circulation circuit comprises a bypass line in which the ozone supply device is arranged.

9. A cooling tower comprising a water treatment system according to claim 1.

10. A method for water treatment wherein a fluid is conducted from a fluid basin into a circulation circuit substantially pure ozone is introduced into the fluid in the circulation circuit by means of a swirl chamber reactor, and subsequently the fluid is again returned from the circulation circuit into the fluid basin.

11. The water treatment system according to claim 1, wherein the swirl chamber reactor is spiral-shaped or egg-shaped.

12. The water treatment system according to claim 4, wherein the lime filter is a membrane filter.
